(19) United States
(12) Patent Application Publication
(10) Pub. No.: US 2016/0190632 A1
(43) Pub. Date: Jun. 30, 2016

(54) FUEL CELL UNIT

(71) Applicant: TOYOTA JIDOSHA KABUSHIKI KAISHA, Toyota-shi (JP)

(72) Inventor: Michitaro ITOGA, Okazaki-shi (JP)

(73) Assignee: TOYOTA JIDOSHA KABUSHIKI KAISHA, Toyota-shi (JP)

(21) Appl. No.: 14/972,683

(22) Filed: Dec. 17, 2015

(30) Foreign Application Priority Data
Dec. 24, 2014 (JP) 2014-260255

(51) Int. Cl. H01M 8/2475; H01M 8/248

(52) U.S. Cl. CPC H01M 8/2475; H01M 8/248; H01M 2250/20

(57) ABSTRACT

A fuel cell unit includes: a fuel cell having a plurality of stacked unit cells, the unit cells being tightened together by a compressive load for compression in a stacking direction; a casing having a wall surface which defines a space for housing the fuel cell therein and which faces the stacking direction, the wall surface being subject to reaction force against the compressive load in the stacking direction and the wall surface having a through hole formed so as to extend through from the space to outside of the wall surface; and a ventilation member which is to be fitted into the through hole and which allows ventilation between the space and the outside of the wall surface to be fulfilled in the through hole. Thus, in the fuel cell unit, ventilation inside the casing is fulfilled while strength degradation of the casing is suppressed.

### CROSS REFERENCE TO RELATED APPLICATIONS

This application claims priority to Japanese Patent Application No. 2014-260255 filed on Dec. 24, 2014, the entire contents of which are incorporated by reference herein.

### TECHNICAL FIELD

The present invention relates to a fuel cell unit.

### BACKGROUND ART

There has been provided a fuel cell unit in which a fuel cell is housed in a casing. In such a fuel cell unit, the fuel cell is made up by stacking a plurality of unit cells in a stacking direction, the unit cells being tightened together by a compressive load for compression in the stacking direction. The casing for housing the fuel cell has a plurality of wall surfaces that define the space for housing the fuel cell, the plurality of wall surfaces being subject to reaction force against the compressive load of the fuel cell. An example of such a fuel cell unit is one in which an opening extending in the stacking direction is formed in a wall surface extending along the stacking direction of the fuel cell out of the plurality of wall surfaces so as to allow ventilation inside the casing to be fulfilled through this opening (JP No. 5293813).

### SUMMARY

In the fuel cell unit as in JP No. 5293813, since the opening extending in the stacking direction is formed in the wall surface of the casing extending in the stacking direction to fulfill the internal ventilation of the casing, there has been a problem that the strength of the casing degrades. Thus, there has been a desire for a technique that allows the internal ventilation of the casing to be fulfilled while the strength degradation of the casing is suppressed.

### Solution to Problem

The present invention, having been accomplished to solve at least part of the above-described problems, can be implemented in the following aspects.

(1) In one aspect of the invention, there is provided a fuel cell unit. The fuel cell unit includes: a fuel cell having a plurality of stacked unit cells, the unit cells being tightened together by a compressive load for compression in a stacking direction; a casing having a wall surface which defines a space for housing the fuel cell therein and which faces the stacking direction, the wall surface being subject to reaction force against the compressive load in the stacking direction and the wall surface having a through hole formed so as to extend through from the space to outside of the wall surface; and a ventilation member which is to be fitted into the through hole and which allows ventilation between the space and the outside of the wall surface to be fulfilled in the through hole. According to this aspect, a wall surface facing the stacking direction out of wall surfaces of the casing is reinforced enough, as compared with the wall surfaces extending along the stacking direction, and still more, the ventilation member is fitted to the through hole formed in the wall surface facing the stacking direction. Thus, ventilation inside the casing can be fulfilled while strength degradation of the casing is suppressed. Furthermore, since the through hole to which the ventilation member is to be fitted is greater in strength against the stress applied in the extending-through direction than in strength against the stress applied in a direction orthogonal to the extending-through direction, it follows that the strength degradation can be suppressed to larger extents when the through holes to which the ventilation member is to be fitted is provided in a wall surface facing the stacking direction than when provided in a wall surface extending along the stacking direction.

(2) In the fuel cell unit of the above-described aspect, the through hole may have a circular-shaped cross section, wherein a female thread may be formed in an inner circumferential surface of the through hole, and the ventilation member may be formed into a cylindrical shape, wherein a male thread mutually fittable to the female thread may be formed in an outer circumferential surface of the ventilation member. According to this aspect, since the ventilation member does not need to be additionally provided with any structure (bolt mounting holes, etc.) for fixing the ventilation member to the wall surface, the length to which the ventilation member is protruded outward of the wall surface can be suppressed. As a result, a downsizing of the fuel cell unit can be achieved. Also, the through hole is formed into a relatively stress-suppressible circular-shaped cross section, and the cylindrical-shaped ventilation member is fitted to the through hole. Thus, strength degradation of the casing can be further suppressed.

(3) In the fuel cell unit of the above-described aspect, the through hole may be formed at such a position that the fuel cell can be pressed in the stacking direction via the through hole from outside of the casing. According to this aspect, since the casing does not need to be additionally provided with the through hole for pressing the fuel cell in manufacturing process of the fuel cell unit, manufacturing cost of the fuel cell unit can be suppressed.

(4) In the fuel cell unit of the above-described aspect, a grip may be formed in the ventilation member, the grip being protruded outward of the wall surface with the ventilation member fitted to the through hole. According to this aspect, since a worker is allowed to hold the grip to make the ventilation member fitted to the through hole, the ventilation member can be assembled to the casing easily.

The present invention is not limited to fuel cell units and may also be applied to various forms such as vehicles on which a fuel cell unit is mounted or methods for manufacturing a fuel cell unit. Moreover, the invention is in no sense limited to the above-described aspects and, of course, may be fulfilled in various forms unless those forms depart from the gist of the invention.

### BRIEF DESCRIPTION OF DRAWINGS

FIG. 1 is an explanatory view showing an outlined structure of a vehicle;

FIG. 2 is a sectional view showing a cross-sectional configuration of the vehicle;

FIG. 3 is a perspective view showing an appearance configuration of a casing of a fuel cell unit;

FIG. 4 is an exploded perspective view of the casing;

FIG. 5 is an explanatory view showing a cross section of a ventilation member fitted to a through hole;

FIG. 6 is an explanatory view showing a ventilation member in another embodiment;

FIG. 7 is an explanatory view showing a ventilation member in another embodiment; and

FIG. 8 is an explanatory view showing a ventilation member in another embodiment.

### DESCRIPTION OF EMBODIMENTS

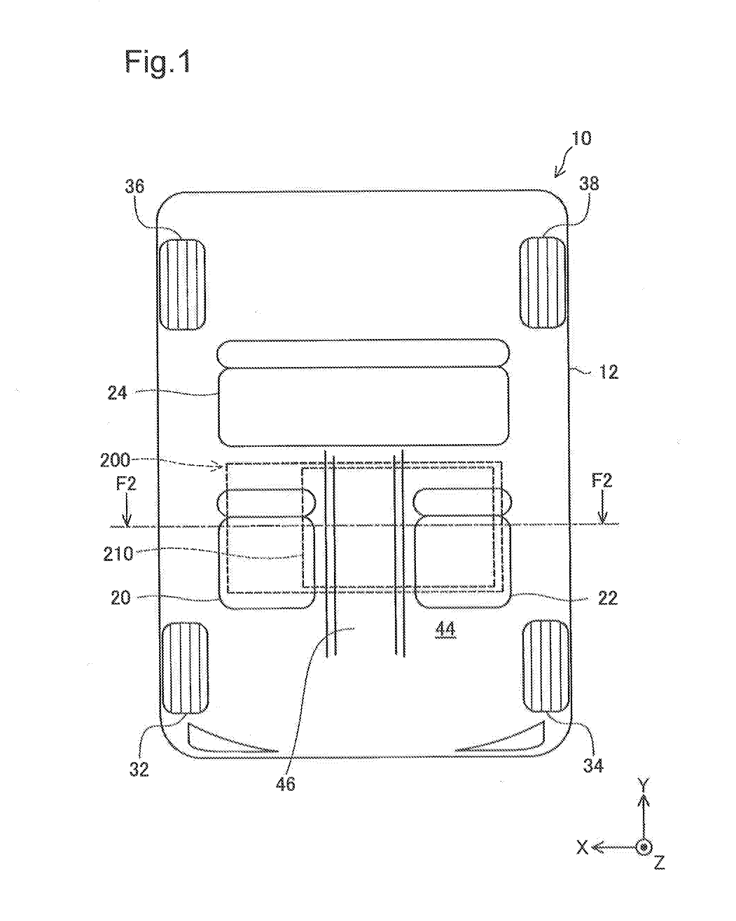

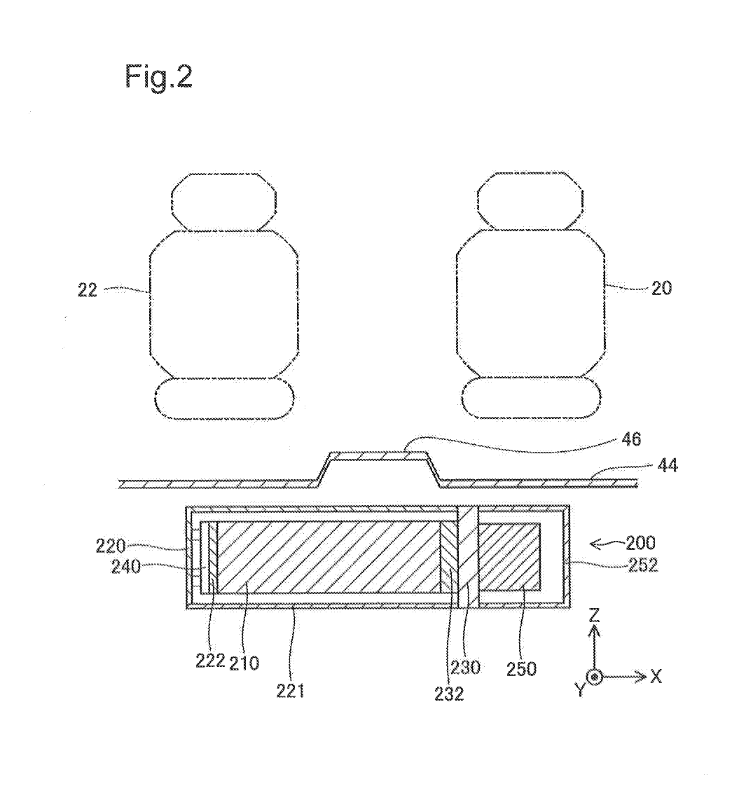

FIG. 1 is an explanatory view showing an outlined structure of a vehicle 10. FIG. 2 is a sectional view showing a cross-sectional configuration of the vehicle 10. Shown in FIG. 2 is a cross section of the vehicle 10 taken along a line F2-F2 in FIG. 1. In FIG. 1, XYZ axes orthogonally intersecting one another are shown. The X axis in the XYZ axes of FIG. 1 is a coordinate axis directed rightward of the vehicle 10 from the left side of the vehicle 10 as the vehicle 10 is viewed from the rear. The Y axis in the XYZ axes of FIG. 1 is a coordinate axis directed rearward from the forward side of the vehicle 10. The Z axis in the XYZ axes of FIG. 1 is a coordinate axis directed upward from the downward side in the gravitational direction. The XYZ axes in FIG. 1 correspond to XYZ axes in the other drawings.

The vehicle 10 includes a vehicle body 12 and a fuel cell unit 200. The vehicle 10 travels with use of electric power generated by the fuel cell unit 200. The vehicle body 12 of the vehicle 10 forms an outer shell of the vehicle 10. The vehicle body 12 is equipped with seats 20, 22, 24 as well as wheels 32, 34, 36, 38.

The seats 20, 22, 24 are made up so as to allow passengers to be seated thereon. The seat 20 is positioned on the right side (positive side in the X-axis direction) of the vehicle body 12. The seat 22 is positioned on the left side (negative side in the X-axis direction) of the vehicle body 12. The seat 24 is positioned rearward (positive side in the Y-axis direction) of the seats 20 and 22.

The wheels 32, 34, 36, 38 are driven with use of electric power generated by the fuel cell unit 200. In other embodiments, driving wheels of the vehicle 10 may be only the wheels 32, 34 positioned in the front side or only the wheels 36, 38 positioned in the back side.

The vehicle body 12 of the vehicle 10 has a floor 44 made by sheet forming. In this embodiment, a protruding portion 46 is formed in the floor 44. The protruding portion 46 is a portion of the area of the floor 44 which protrudes upward in the gravitational direction (toward the positive side in the Z-axis direction) and which extends from front toward rear side of the vehicle 10.

The fuel cell unit 200 is provided on the lower side of the floor 44 in the gravitational direction (on the negative side in the Z-axis direction). In this embodiment, the fuel cell unit 200 is positioned at a center of the four wheels 32, 34, 36, 38. In this embodiment, the fuel cell unit 200 is positioned on the lower side of the seats 20, 22 in the gravitational direction (on the negative side in the Z-axis direction). In this embodiment, the fuel cell unit 200 is positioned on the lower side of the protruding portion 46 in the gravitational direction (on the negative side in the Z-axis direction).

The fuel cell unit 200 of the vehicle 10 is a device in which a fuel cell stack 210 is housed. The fuel cell stack 210 is made up by stacking a plurality of unit cells 212 which generate electric power through electrochemical reaction of a reactant gas and which are tightened together by a compressive load for compression in a stacking direction. In this embodiment, the stacking direction is along the X-axis direction. In this embodiment, the fuel cell stack 210, receiving supply of hydrogen gas and air, generates electric power through electrochemical reaction between hydrogen and oxygen.

As shown in FIG. 2, the fuel cell unit 200 includes, in addition to the fuel cell stack 210, a casing 220, a lower cover 221, an insulating plate 222, a stack manifold 230, an insulating plate 232, an end plate 240, auxiliary machinery 250, and an auxiliary machinery cover 252.

The casing 220 of the fuel cell unit 200 is a box-shaped electrical conductor. The fuel cell stack 210 is housed inside the casing 220. The lower cover 221 of the fuel cell unit 200 is a plate-shaped electrical conductor. The lower cover 221 is attached to an opening of the casing 220 to seal the fuel cell stack 210 inside the casing 220.

The insulating plate 222 of the fuel cell unit 200 electrically insulates the fuel cell stack 210 and the end plate 240 from each other. The insulating plate 232 of the fuel cell unit 200 electrically insulates the fuel cell stack 210 and the stack manifold 230 from each other. The end plate 240 of the fuel cell unit 200 holds the fuel cell stack 210 inside the casing 220 via the insulating plate 222.

The stack manifold 230 of the fuel cell unit 200 is a plate-shaped electrical conductor. In the stack manifold 230, various flow paths that allow a reactant gas and a cooling medium to flow to the fuel cell stack 210 are formed. The stack manifold 230 is attached to the casing 220.

The auxiliary machinery 250 of the fuel cell unit 200 supplies hydrogen and air to the fuel cell stack 210. In this embodiment, the auxiliary machinery 250 is attached to the stack manifold 230. The auxiliary machinery cover 252 of the fuel cell unit 200 is an electrical conductor that covers the auxiliary machinery 250. In this embodiment, the auxiliary machinery cover 252 is attached to the stack manifold 230.

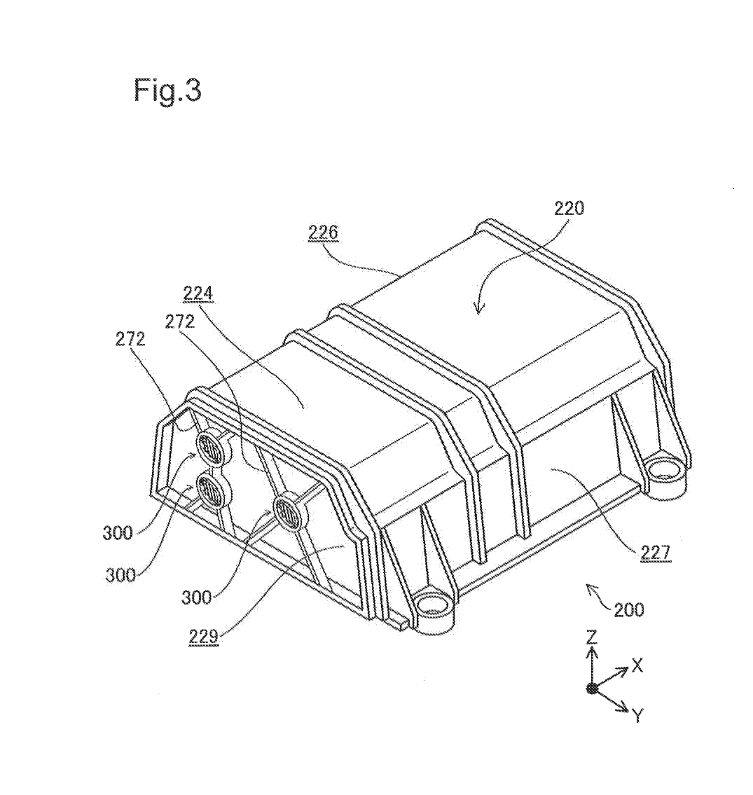

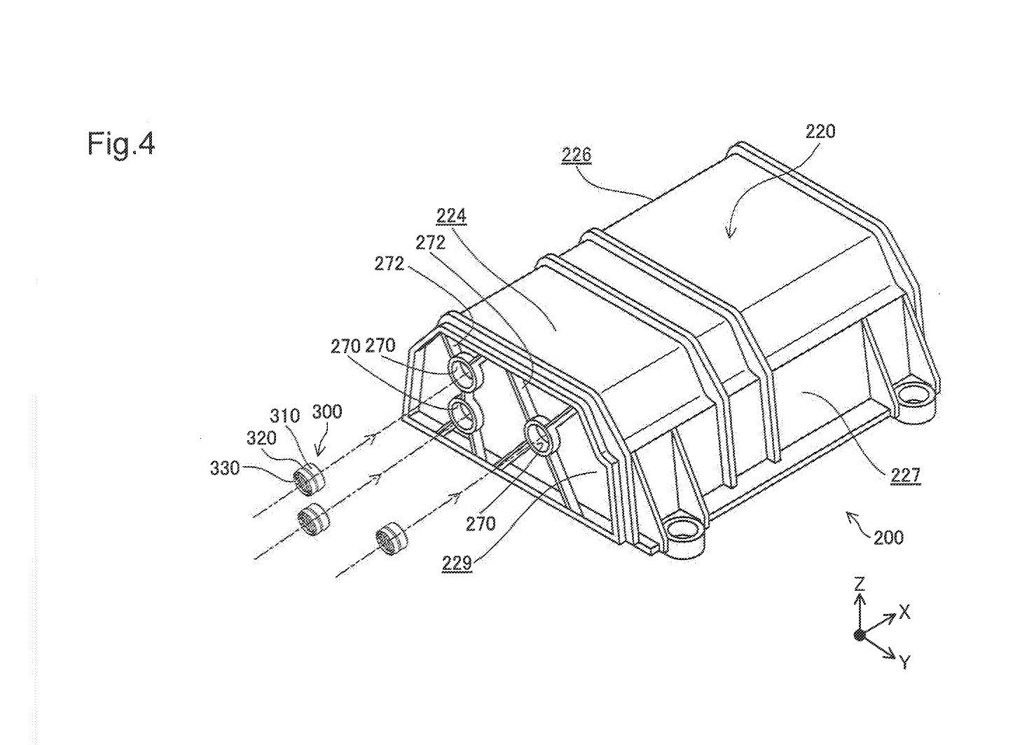

FIG. 3 is a perspective view showing an appearance configuration of the casing 220 of the fuel cell unit 200. FIG. 4 is an exploded perspective view of the casing 220. The casing 220 has a wall surface 224, a wall surface 226, a wall surface 227 and a wall surface 229 as wall surfaces that define a space for housing the fuel cell stack 210 therein.

The wall surface 224 of the casing 220 is a wall surface extending along the stacking direction, being a wall surface extending along the XY plane in this embodiment. The wall surface 224 connects the wall surface 226 and the wall surface 227 to each other. The wall surface 226 and the wall surface 227 of the casing 220 are wall surfaces extending along the stacking direction, being mutually opposing wall surfaces extending along the XZ plane in this embodiment. The wall surface 229 of the casing 220 is a wall surface facing the stacking direction, being a wall surface extending along the YZ plane in this embodiment. In this embodiment, the wall surface 229 connects with end portions of the individual wall surfaces 224, 226, 227 on the negative side of their respective X-axis directions. That is, the wall surface 229 is a wall placed on one side in the stacking direction. The wall surfaces 224, 226, 227, 229 are subject to reaction force against a compressive load that compresses the fuel cell stack 210 in the stacking direction. In this embodiment, the wall surface 229 facing the stacking direction has ribs 272 formed therein for ensuring enough strength.

In the wall surface 229, through holes 270 is formed. through holes 270 extend through from the space, in which the fuel cell stack 210 is housed, to the outside of the wall surface 229. In this embodiment, each through hole 270 has a circular-shaped cross section. In other embodiments, each through hole 270 may have other cross-sectional shapes such as polygonal, elliptic or sectorial shapes other than the circular shape. In this embodiment, the through holes 270 are formed at such positions that the fuel cell stack 210 can be pressed in the stacking direction via the through holes 270 from outside the casing 220. In other embodiments, the through holes 270 do not have to be formed at such positions that the fuel cell stack 210 can be pressed in the stacking direction via the through holes 270 from outside the casing 220. In this embodiment, three through holes 270 are formed in the wall surface 229. The number of the through holes 270 in the wall surface 229 may be one or two or four or more.

Ventilation members 300 are provided at the through holes 270 of the wall surface 229, respectively. Each ventilation member 300 is formed into a cylindrical shape fittable to the through hole 270, so that ventilation between the space having the fuel cell unit 200 housed therein and the outside of the wall surface 229 can be provided.

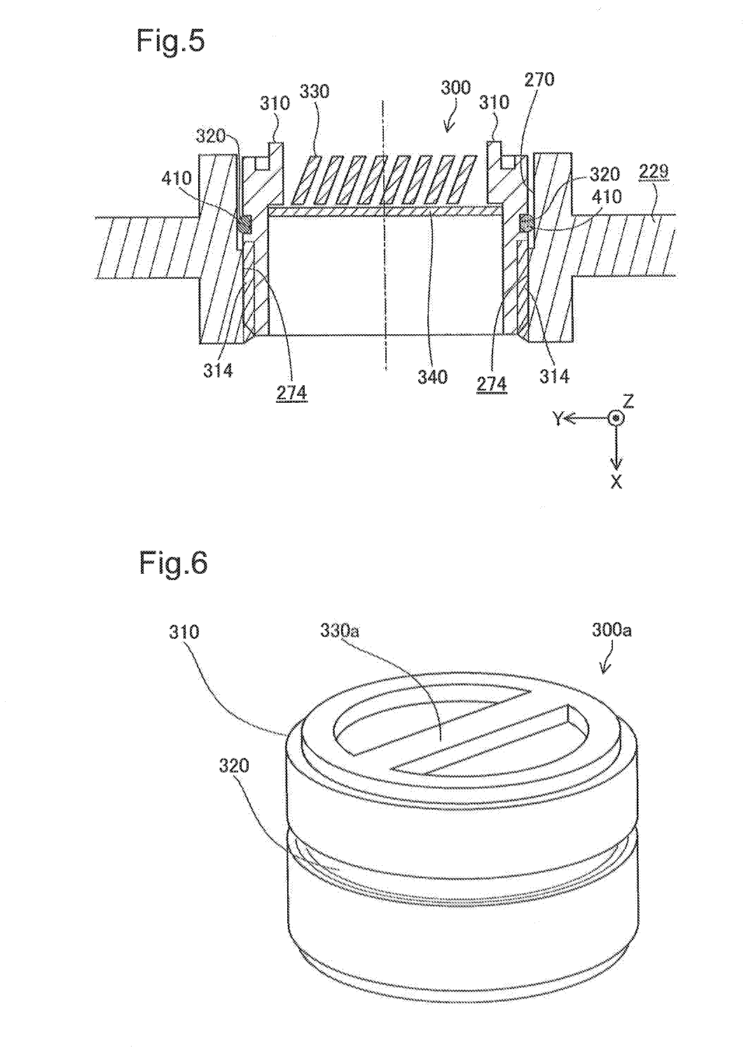

FIG. 5 is an explanatory view showing a cross section of a ventilation member 300 fitted to the through hole 270. Each ventilation member 300 includes a frame body 310, a filter 340 and a gasket 410.

The frame body 310 of the ventilation member 300 is formed into a cylindrical shape fittable to the through hole 270, forming an outer shell of the ventilation member 300. In this embodiment, a female thread 274 is formed on an inner circumferential surface of the through hole 270, and a male thread 314 fittable to the female thread 274 is formed on an outer circumferential surface of the frame body 310. By mutual fitting between the female threads 274 of the through holes 270 and the male threads 314 of the frame body 310, the ventilation members 300 are fixed to the through holes 270. In this embodiment, each female thread 274 is formed on part of the inner circumferential surface of the through hole 270, and each male thread 314 is formed on part of the outer circumferential surface of the frame body 310.

In this embodiment, a groove 320 into which a gasket 410 is fitted is formed on the outer circumferential surface of the frame body 310. In this embodiment, the gasket 410 is made from rubber having elasticity (e.g., silicone rubber, fluororubber, etc.), serving for sealing between the inner circumferential surface of the through hole 270 and the outer circumferential surface of the frame body 310.

In this embodiment, a louver 330 in which a plurality of plates are arrayed with intervals is formed inside the frame body 310. In this embodiment, with the ventilation members 300 fitted to the through holes 270, the louver 330 is a portion protruded outward of the wall surface 229. In this embodiment, a filter 340 is provided inside the louver 330. The filter 340 permits gases to permeate therethrough and blocks liquids from permeating therethrough.

According to the embodiment described above, the wall surface 229 facing the stacking direction out of the wall surfaces of the casing 220 is reinforced enough by the ribs 272, as compared with the wall surfaces 224, 226, 227 extending along the stacking direction, and still more, the ventilation members 300 are fitted to the through holes 270 formed in the wall surface 229 facing the stacking direction. Thus, ventilation inside the casing 220 can be fulfilled while strength degradation of the casing 220 is suppressed. Furthermore, since the through holes 270 to which the ventilation members 300 are to be fitted are greater in strength against the stress applied in the extending-through direction than in strength against the stress applied in directions orthogonal to the extending-through direction. Accordingly, the strength degradation can be suppressed to larger extents when the through holes 270 to which the ventilation members 300 are to be fitted are provided in a wall surface facing the stacking direction than when provided in a wall surface extending along the stacking direction.

Further, since the ventilation members 300 do not need to be additionally provided with any structure (bolt mounting holes, etc.) for fixing the ventilation members 300 to the wall surface 229, the length to which the ventilation members 300 are protruded outward of the wall surface 229 can be suppressed. As a result, a downsizing of the fuel cell unit 200 can be achieved. Also, the through holes 270 are formed each into a relatively stress-suppressible circular-shaped cross section, and the cylindrical-shaped ventilation members 300 are fitted to those through holes 270. Thus, strength degradation of the casing 220 can be further suppressed.

Furthermore, since the casing 220 does not need to be additionally provided with the through holes 270 for pressing the fuel cell stack 210 in manufacturing process of the fuel cell unit 200, manufacturing cost of the fuel cell unit 200 can be suppressed.

The present invention is not limited to the above-described embodiment, working examples and modifications and may be fulfilled in various configurations unless those configurations depart from the gist of the invention. For example, technical features in the embodiment, working examples and modifications corresponding to technical features in the individual aspects described in the section of Summary of the Invention may be replaced or combined with one another, as required, in order to solve part or entirety of the above-described problems or to achieve part or entirety of the above-described advantageous effects. Moreover, those technical features may be deleted, as required, unless herein otherwise described as indispensable.

FIG. 6 is an explanatory view showing a ventilation member 300a in another embodiment. The ventilation member 300a is structurally similar to the ventilation member 300 of the above-described embodiment except that a grip 330a is formed in the frame body 310. The grip 330a of the ventilation member 300a is a portion that is protruded outward of the wall surface 229 while the ventilation member 300a is fitted to the through hole 270. According to this embodiment, as in the above-described embodiment, ventilation inside the casing 220 can be fulfilled while strength degradation of the casing 220 is suppressed. Also, since a worker is allowed to hold the grip 330a to make the ventilation member 300a fitted to the through hole 270, the ventilation member 300a can be assembled to the casing 220 easily.

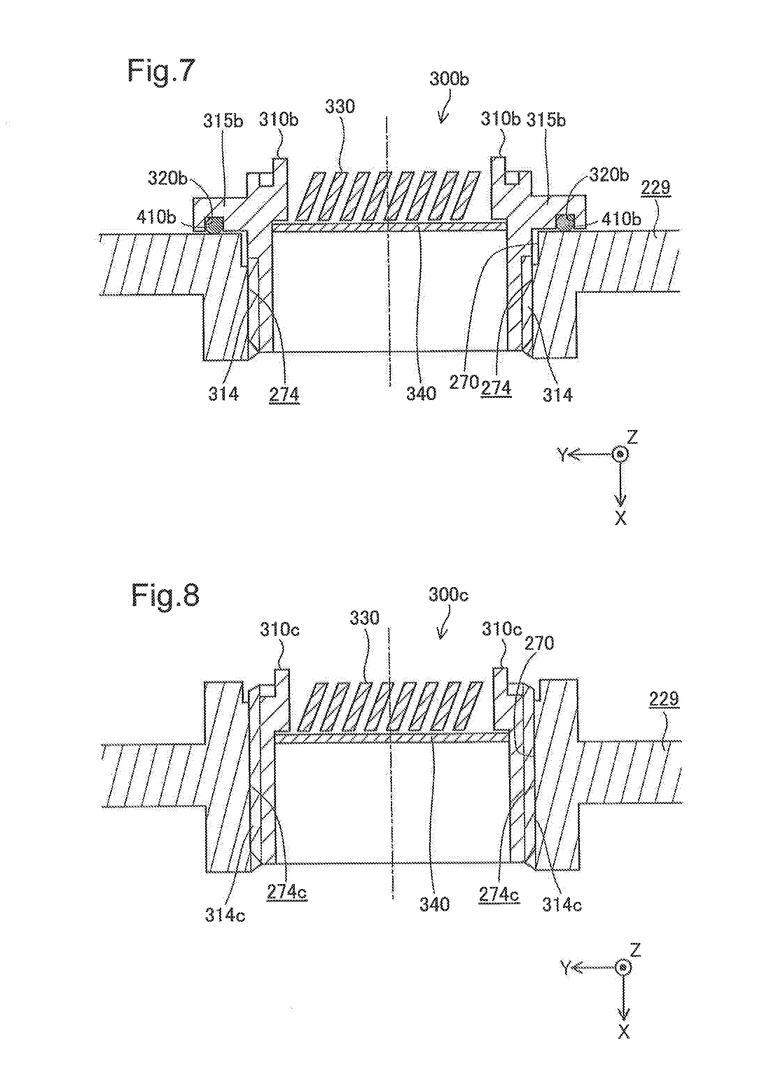

FIG. 7 is an explanatory view showing a ventilation member 300b in another embodiment. The ventilation member 300b is structurally similar to the ventilation members 300 of the above-described embodiment except that a flange portion 315b is formed in a frame body 310b and that a gasket 410b is provided in the flange portion 315b. In the frame body 310b of the ventilation member 300b, the flange portion 315b radially protruded further than the through hole 270 is formed on the negative side in the X-axis direction. A groove portion 320b to which the gasket 410b is to be fitted is formed at a site facing the wall surface 229 in the flange portion 315b. The gasket 410b seals the wall surface 229 and the flange portion 315b from each other. According to this embodiment, as in the above-described embodiment, ventilation inside the casing 220 can be fulfilled while strength degradation of the casing 220 is suppressed.

FIG. 8 is an explanatory view showing a ventilation member 300c in another embodiment. The ventilation member 300c is structurally similar to the ventilation members 300 of the above-described embodiment except that a male thread 314c is formed over the entire range of the outer circumferential surface of a frame body 310c. According to this embodiment, as in the above-described embodiment, ventilation inside the casing 220 can be fulfilled while strength degradation of the casing 220 is suppressed. Also, the length to which the ventilation member 300c is protruded outward of the wall surface 229 can be further suppressed.

In another embodiment, the ventilation member 300 may be fixed to the through hole 270 by mutual fitting between a recess portion formed in the inner circumferential surface of the through hole 270 and a protruding portion formed in the outer circumferential surface of the ventilation member 300.

What is claimed is:

1. A fuel cell unit comprising:
a fuel cell having a plurality of stacked unit cells, the unit cells being tightened together by a compressive load for compression in a stacking direction;
a casing having a wall surface which defines a space for housing the fuel cell therein and which faces the stacking direction, the wall surface being subject to reaction force against the compressive load in the stacking direction and the wall surface having a through hole formed so as to extend through from the space to outside of the wall surface; and
a ventilation member which is to be fitted into the through hole and which allows ventilation between the space and the outside of the wall surface to be provided in the through hole.

2. The fuel cell unit in accordance with claim 1, wherein
the through hole has a circular-shaped cross section, wherein a female thread is formed in an inner circumferential surface of the through hole, and
the ventilation member is formed into a cylindrical shape, wherein a male thread mutually fittable to the female thread is formed in an outer circumferential surface of the ventilation member.

3. The fuel cell unit in accordance with claim 1, wherein the through hole is formed at such a position that the fuel cell can be pressed in the stacking direction via the through hole from outside of the casing.

4. The fuel cell unit in accordance with claim 1, wherein a grip is formed in the ventilation member, the grip being protruded outward of the wall surface with the ventilation member fitted to the through hole.
